(19) United States
(12) Patent Application Publication
(10) Pub. No.: US 2016/0085489 A1
(43) Pub. Date: Mar. 24, 2016

(54) SYSTEM FOR REMOTE PRINTER PAIRING

(71) Applicant: BreezyPrint Corporation, Oakland, CA (US)

(72) Inventor: Jared Hansen, Oakland, CA (US)

(73) Assignee: BreezyPrint Corporation, Oakland, CA (US)

(21) Appl. No.: 14/857,830

(22) Filed: Sep. 18, 2015

Related U.S. Application Data
(60) Provisional application No. 62/052,570, filed on Sep. 19, 2014.

(51) Int. Cl. G06F 3/12

(52) U.S. Cl. CPC G06F 3/1236; G06F 3/1285; G06F 3/1292; G06F 3/1205

(57) ABSTRACT

A system for facilitating the remote printing of a document by using a mobile device to pair a visually displayable code with a printer by associating the code with a confirmation code printed or conveyed by the printer.

### CROSS-REFERENCE TO RELATED APPLICATIONS

Priority claimed to Provisional Application No. 62/052,570

### STATEMENT REGARDING FEDERALLY SPONSORED RESEARCH OR DEVELOPMENT

Not Applicable

### COPYRIGHT NOTICE

A portion of the disclosure of this patent document contains material which is subject to copyright protection. The copyright owner has no objection to the facsimile reproduction by anyone of the patent document or the patent disclosure but otherwise reserves all copyright rights whatsoever.

### BACKGROUND

The capability of remote and/or mobile printing of documents presents many difficulties of implementation. These difficulties are particularly relevant with respect to the ease and efficiency of setting up or activating a printer for a remote printing system.

### BRIEF DESCRIPTION OF THE DRAWINGS

The foregoing and other features, aspects and advantages of the invention are described in detail below with reference to the drawings of various embodiments, which are intended to illustrate and not to limit the invention. The drawings comprise the following figures in which:

FIG. 1A is a schematic diagram of an embodiment of a remote printing system;

FIG. 1B is a schematic diagram of an embodiment of a remote printing system;

FIG. 1C is a schematic diagram of an embodiment of a remote printing system;

FIG. 2 is a block diagram of an apparatus according to some embodiments;

FIG. 3 is a flowchart of a method according to some embodiments;

FIG. 4 is a block diagram of an example data storage structure according to some embodiments;

FIG. 5 is a diagram of an example printer pairing confirmation page according to some embodiments; and

FIG. 6 is a diagram of an example page of remote printing labels according to some embodiments.

### DETAILED DESCRIPTION OF THE EMBODIMENTS

Certain aspects, advantages, and novel features of various embodiments are described herein. It is to be understood that not necessarily all such advantages may be achieved in accordance with any particular embodiment. Thus, for example, those skilled in the art will recognize that embodiments may be effectuated and/or carried out in a manner that achieves one advantage or group of advantages as taught herein without necessarily achieving other advantages as may be taught or suggested herein.

Although several embodiments, examples and illustrations are disclosed herein, it will be understood by those of ordinary skill in the art that the embodiments described herein extend beyond the specifically disclosed embodiments, examples and illustrations and include other uses and obvious modifications and equivalents thereof. Embodiments are described herein with reference to the accompanying figures, wherein like numerals refer to like elements throughout. The terminology used in the description presented herein is not intended to be interpreted in any limited or restrictive manner simply because it is being used in conjunction with a detailed description of certain specific embodiments. In addition, embodiments may comprise several novel features and it is possible that no single feature is solely responsible for its desirable attributes or is essential to practicing the embodiments described herein.

Applicant has recognized that users of computing devices often receive or create documents and/or other files via a mobile device (for example but not limited to a handheld smart phone such as a BLACKBERRY, IPHONE, or other portable computing device operable to receive and/or create documents). Applicant has further recognized that users of such mobile devices may desire to print documents received or created via such mobile devices. For example, such mobile devices may have a screen/display that is small or does not permit easy reading and/or reviewing of such documents or easy review of such documents by multiple users. Applicant has further recognized that configuration, activation, and/or pairing of printer devices to operate within a remote printing system can be simplified and streamlined to increase system setup and usage efficiencies.

It should be understood that the embodiments described herein are not limited to use with mobile devices (although the embodiments are described mainly with reference to such devices, for ease of understanding), but are equally applicable to any computing device that does not have direct access to a printing device on which a user desires to print a document and any reference to a “mobile device” herein should generally be understood to equally refer to any such computing device, as appropriate, unless otherwise specifically limited (e.g., in a claim) to a particular species of mobile device such as, but not limited to, a smart phone, a wireless telephone, a tablet device, and/or a “smart” watch. A “document” as the term is utilized herein, generally refers to any collection of data capable of being rendered on a tangible medium (e.g., paper), such as a WORD, EXCEL, PDF file, or an image file. A “physical document” is a rendering of a document in a physical form—e.g., a fixation of data and/or elements of the document on one or more tangible mediums, such as paper.

Applicant has still further recognized that although various solutions for printing documents from mobile devices are available, these solutions do not allow a user to print a document from a mobile device in certain circumstances, thus leaving a need for a solution that expands the situations in which a user may easily print a document from, e.g., a mobile device.

For example, a user might be on her morning commute to her company office, and receive via her mobile device an email containing a document attachment that she would like to review as soon as she reaches the office, but which will take significant time to print. Accordingly, she may desire to have her office printer print the document so that the printed document will be waiting for her by the time she arrives. However, if the company at which the user works has not retained an Information Technology (IT) professional to install enterprise printing capabilities that would allow the user to print from her mobile device to a company printer (an expensive proposition that many companies do not provide), the user is unable to do so. Further, even if the user's company has provided such enterprise-level printing capability, the user would be restricted to printing the document to whichever enterprise printer was previously selected by the IT professional for such a purpose. The systems, methods, and devices disclosed herein allow the user to use her mobile device to print the document attachment via her office printer, irrespective of whether the company IT professional has provided any enterprise-level printing capabilities and irrespective of which enterprise printer the IT professional has selected for such printing. Further, in accordance with embodiments described herein, the user could alternately or additionally print the document to another printer (e.g., her home printer and/or one or more designated public and/or third-party printers) as well, such that the document will be waiting for her when she returns home (or arrives at the public/third-party printer location, as the case may be) and/or could be queued for printing by such home-based, third-party, and/or public printer location upon a receipt, transmittal, and/or occurrence of a printing and/or release trigger as described herein.

In another example, a user might be at home when he receives, via a mobile device, an email containing an attachment he needs to review promptly. Though he may be in his home and near his home office, with a computer and a printer just inches away, he cannot print the document without first either logging in to his employer's virtual private network and going through a series of other complicated procedures (if, indeed, he is able to print the document at all) or logging into his computer and accessing a remote email system to retrieve the email and attachment for printing on his home computer (and even then is only able to print the document if he has the appropriate program installed locally on his computer for viewing files in the format in which the document is saved such as PDF or DOCX). The systems, methods, and devices disclosed herein allow a user in such a situation to use his mobile device to print the document attachment via his home office printer without having to log in to the employer's email system or engaging in other complicated steps or procedures, without his mobile device requiring BLUETOOTH or other specialized capabilities for communicating directly with a printer and/or without first having to determine a network address or other identifier of his home office printer.

Disclosed herein are systems, methods, and devices for transmitting and/or printing from a mobile device (and/or other computing device not directly connected to or in communication with a printer) to a printer connected to a network and/or connected to another computer. The embodiments disclosed herein may comprise at least three computers: (i) a mobile device; (ii) an intermediary server, for example, a server operable to communicate over the Internet or other network (referred to as a “remote print server” herein); and (iii) a networked/Internet connected printer with a built-in spooling system and/or a networked/Internet connected computer connected (via a network or otherwise) to a printer (referred to as a “printing device”, or more specifically, a “public” or “third-party” printing device, herein, as the case may be). In accordance with some embodiments, while the mobile device and the printing device may be under the control or operation of the user, the remote print server is under the control or operation of a entity providing a service that allows the user to print a document from his mobile device to a printing device to which the mobile device does not otherwise have access. In an embodiment, each of the foregoing devices can operate/run respective software configured to enable remote printing from a mobile device or other computing device not having direct access to the printing device. The software can be easy to use, platform-independent, printer-independent, and/or free of any enterprise-level installation requirements for business users.

In accordance with one embodiment, a remote print server is operable to receive, in association with a user identifier uniquely identifying a user, an indication of at least one computing device operable to print a document, thereby receiving an indication of at least one printing device; store the indication of the at least one printing device in association with the user identifier prior to receiving any requests to print documents in association with the user identifier; receive from a mobile device a request to print a document, the request including the user identifier; receive from the mobile device a selection of the at least one printing device associated with the user identifier, thereby determining a selected printing device; receive from the mobile device data comprising the document; place the document in a print queue for the selected printing device; and transmit the document to the selected printing device for printing. In some embodiments, information defining and/or identifying one or more print-timing rules such as print release triggers may be transmitted and/or otherwise provided to the printer (e.g., particularly in the case that the printer comprises a public and/or third-party printer).

In some embodiments, the selection of the printing device may be subject to, based on, and/or comprise a pairing, configuration, and/or activation of the printing device as described herein.

In accordance with one embodiment, a non-transitory memory and/or non-transitory storage medium stores (i) a database storing an indication of a plurality of registered users, each registered user being associated with at least one mobile device and at least one printing device; (ii) an application for receiving documents from mobile devices to be printed on printing devices specified by a registered user, the application operable to listen for any requests from mobile devices for the printing of documents, receive from the mobile devices documents to be printed, and store the documents to be printed in an appropriate print queue associated with a printing device indicated by a communication from the mobile device from which a request to print a document was received; and (iii) an application for orchestrating the printing of a document on a printing device, the application operable to listen for any print queue queries from printing devices, retrieve any print jobs pending in a print queue corresponding to such a querying printing device and, in response to such a query, transmit the document to be printed and/or print release trigger rules to the querying printing device. In some embodiments, the printing device may comprise a printing device to which the mobile device does not otherwise have access, (iv) a database storing indications of a plurality of activated and/or paired printing devices, and/or (v) an application for facilitating pairing, activation, and/or setup of a printing device on the remote printing network and/or system.

In one or more embodiments, the systems, methods, and devices do not require the mobile device to download or store any printer drivers. In one or more embodiments, the systems, methods, and devices may not require installation at an enterprise or corporate level and/or the user may install all the required software without assistance from IT personnel. In one or more embodiments, the remote printing systems, methods, and devices do not require a printer with any special capabilities such as infrared, BLUETOOTH or other wireless protocols. In one or more embodiments, the remote printing systems, methods, and devices do not require the user to know the network address of any printer or of any computer connected to any printer—such as by utilization of the code pairing procedures and/or setup described herein. The remote printing systems, methods, and devices may be used with any number of different operating systems. The remote printing systems, methods, and devices may work with firewalls or other network protection software (for example, by operating through an accessible port, for example, port eighty (80) for hypertext transfer protocol or HTTP).

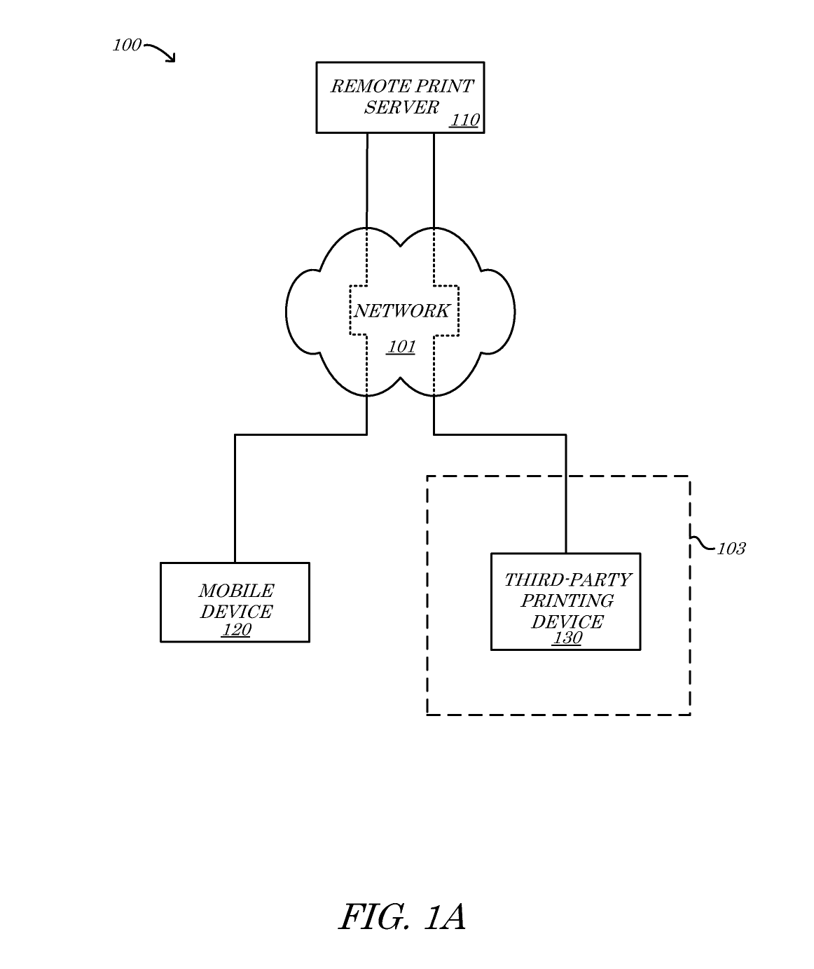

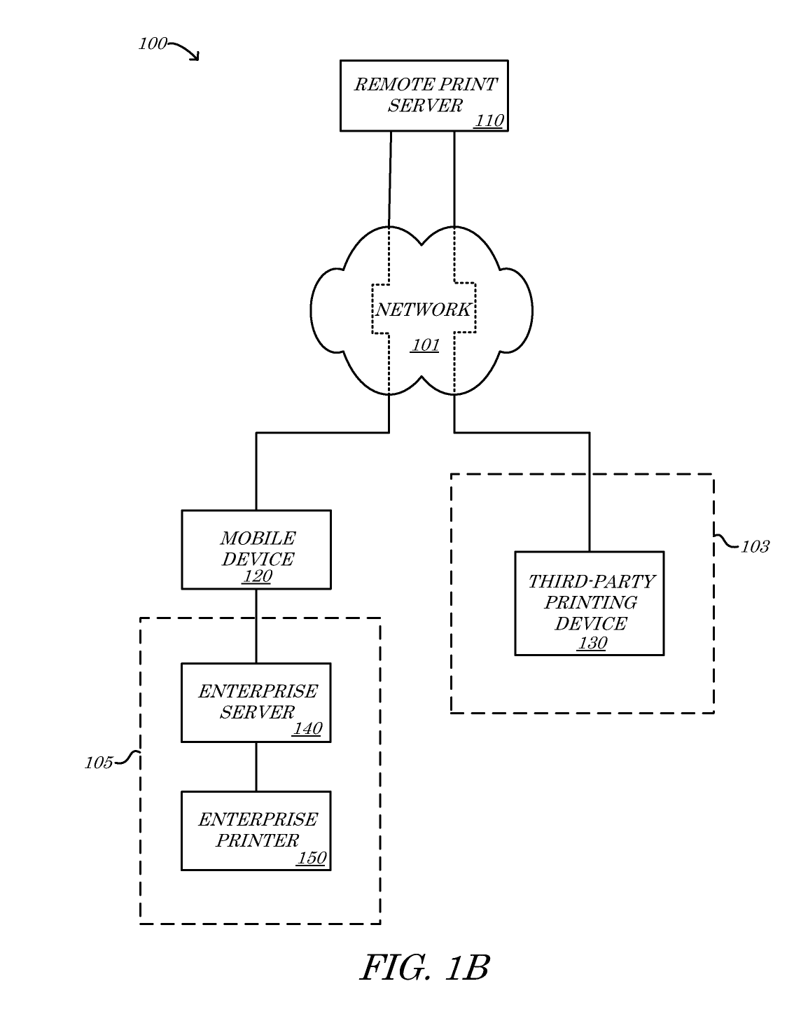

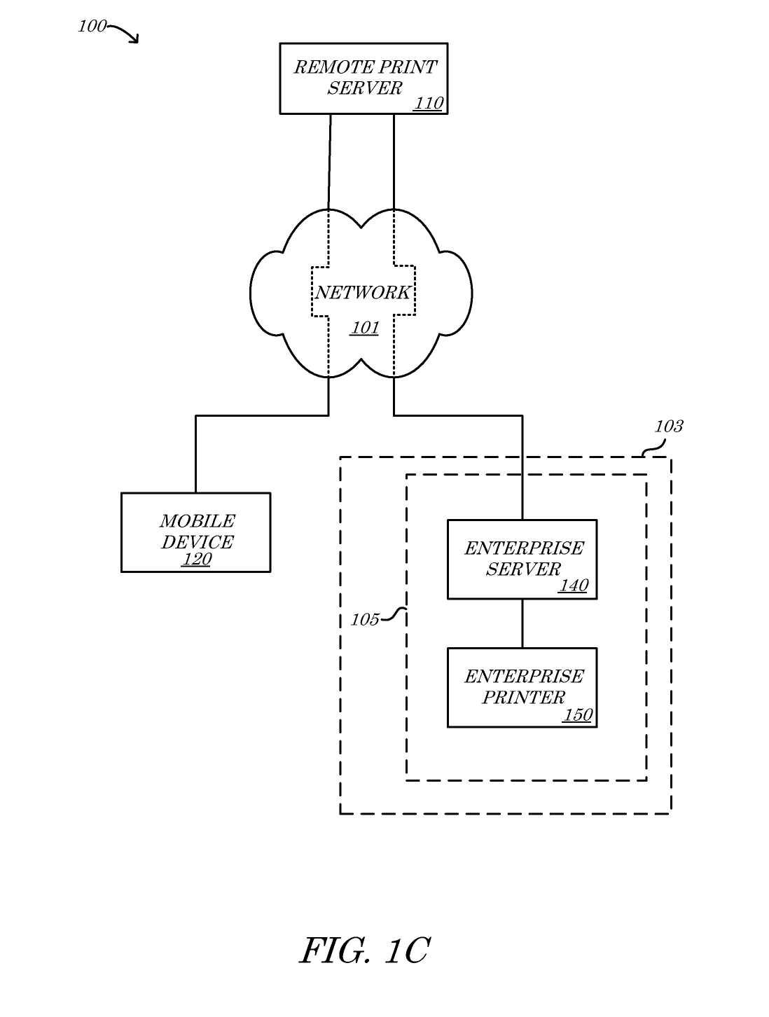

Referring now to FIG. 1A, illustrated therein is an example system 100 consistent with one or more embodiments. The system 100 comprises a remote print server 110, a mobile device 120 and a third-party printing device 130, which in some embodiments may each be operable to communicate with at least one other device of system 100 via a network 101. The network 101 may comprise, for example, the Internet, a Wide-Area Network (WAN), another network or a combination of such networks. Additionally, in some embodiments the third-party printing device 130 may be located behind a firewall 103. In some embodiments, system 100 may be configured such that remote print server 110 may communicate with the third-party printing device 130 in such a way as to be uninhibited by the existence of any firewall 103 (illustrated with a dotted line to represent that some third-party printing devices 130 will be protected by firewalls and others may not). It should be understood that although not shown in FIG. 1A, other networks and devices may be in communication with any of the devices of system 100. For example, the mobile device 120 may be in communication with a mobile network (not explicitly shown) such as a pager or cellular telephone network that accommodates wireless communication with mobile devices as is generally known to those skilled in the art.

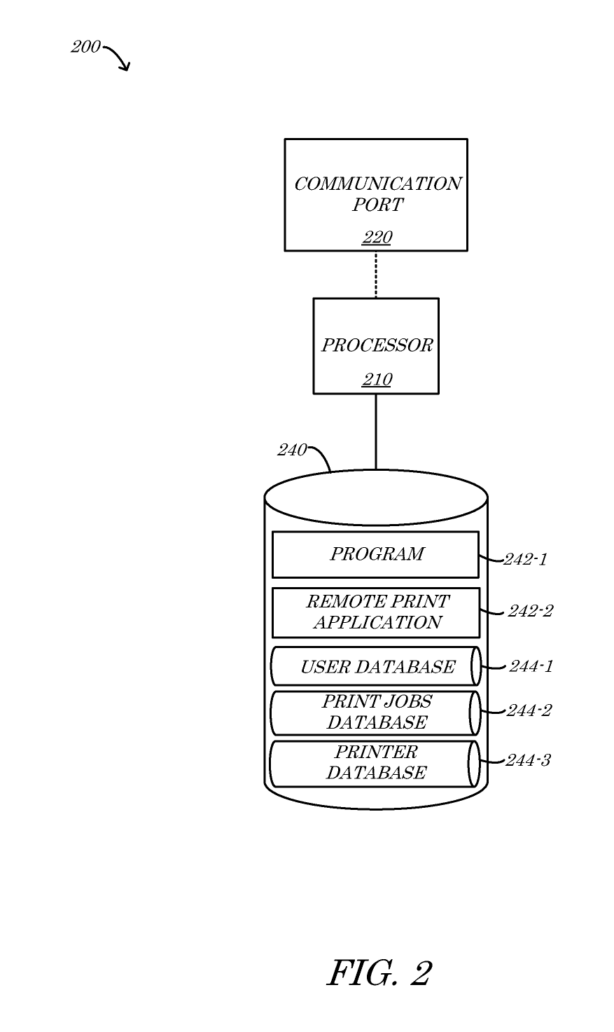

The remote print server 110 may comprise one or more computing devices, working in parallel or series if more than one, operable to facilitate the remote printing functions described herein. A more detailed description of an example remote print server is provided herein with reference to FIG. 2.

The mobile device 120 may comprise, for example, a computing device operable to receive documents (e.g., via email as attachments). In some embodiments the mobile device 120 may comprise a mobile or portable computing device such as a smartphone (e.g., the IPHONE manufactured by APPLE, the BLACKBERRY manufactured by RESEARCH IN MOTION, the PRE manufactured by PALM or the DROID manufactured by MOTOROLA), a Personal Digital Assistant (PDA), cellular telephone, tablet (such as the IPAD manufactured by APPLE), laptop or other portable computing device. In some embodiments, the mobile device 120 may comprise a code capture device (not explicitly shown) such as a camera, barcode scanner, etc.—e.g., for use in conjunction with the printer confirmation codes and remote print label codes as described herein.

The third-party printing device 130 may comprise a printer or a computing device (e.g., a desktop computer) that is operable to cause a printer it is in communication with to print a document (e.g., a physical document), in either case operable to communicate via network 101 (e.g., through firewall 103). In some embodiments, the third-party printing device 130 may not comprise a “third-party” device and may instead be owned and/or operated by a user or customer (not shown in FIG. 1A) of the mobile device 120, in which case it may instead be generally referred to as a “printing device” and/or specifically referred to as a “customer printing device”. In some embodiments the third-party printing device 130 may indeed comprise a “third-party” device and may be owned and/or operated, for example, by an entity (also not shown in FIG. 1A) that owns and/or operates the remote print server 110, and/or a third-party (such as an owner and/or operator of a public and/or quasi-public (e.g., available upon payment and/or commitment to pay a fee) printer, also not shown in FIG. 1A). According to some embodiments, the third-party may comprise, but is not limited to, a retail printing and/or document services establishment (such as a KINKOS or UPS STORE) and/or another public and/or quasi-public print service provider (e.g., a library, a hotel business center, and/or a post office).

It should be understood that each of the devices 110, 120 and 130 may communicate directly or indirectly, via a wired or wireless medium such as the Internet, a Local Area Network (LAN), a WAN or Ethernet, Token Ring, or via any appropriate communications means or combination of communications means. For example, in one embodiment communication among any and all of the devices of system 100 may occur over the Internet through a Web site maintained by a computer on a remote server or over an on-line data network including commercial on-line service providers, bulletin board systems and the like. In yet other embodiments, communication among any of the devices of system 100 may occur over RF, cable TV, satellite links and the like.

The system 100 may be operable to facilitate communication among the devices 110, 120 and 130 using known communication protocols. Possible communication protocols that may be part of the system 100 include, but are not limited to: Ethernet (or IEEE 802.3), ATP, BLUETOOTH, HTTP, HTTPS and Transmission Control Protocol/Internet Protocol (TCP/IP). Communication may be encrypted to ensure privacy and prevent fraud in any of a variety of ways well known in the art, some of which are described herein.

It should be understood that although only one mobile device 120 and one third-party printing device 130 is illustrated, any number of mobile devices 120 and third-party printing devices 130 may be used and, in many embodiments, a large number of each such device would be part of system 100, the number changing as users are added/registered with the system 100 and/or discontinue using the system 100 or update the mobile devices 120 and/or third-party printing devices 130 associated with them.

Referring now to FIG. 1B, illustrated therein is a configuration of system 100 that shows a mobile device 120 in further communication with an enterprise network 105, which includes an enterprise server 140 that is in communication with an enterprise printer 150. An enterprise network 105 may comprise, for example, any private network (e.g., a private network of a particular organization or company) with which a mobile device 120 is operable to communicate, such as a LAN. For example, the LAN 105 may comprise one or more of peer-to-peer architecture, a ring network, a star network, a token bus network, a token ring network, or another technology. In one example embodiment, if the mobile device 120 comprises a BLACKBERRY mobile device, the enterprise server 140 may comprise a BLACKBERRY server 140 that stores and forwards emails to the BLACKBERRY device, as would be understood by one of ordinary skill in the art. It should be noted that the term email, as used herein, refers to communication or exchange of data using the Simple Mail Transfer Protocol (SMTP) or other appropriate or similar protocol.

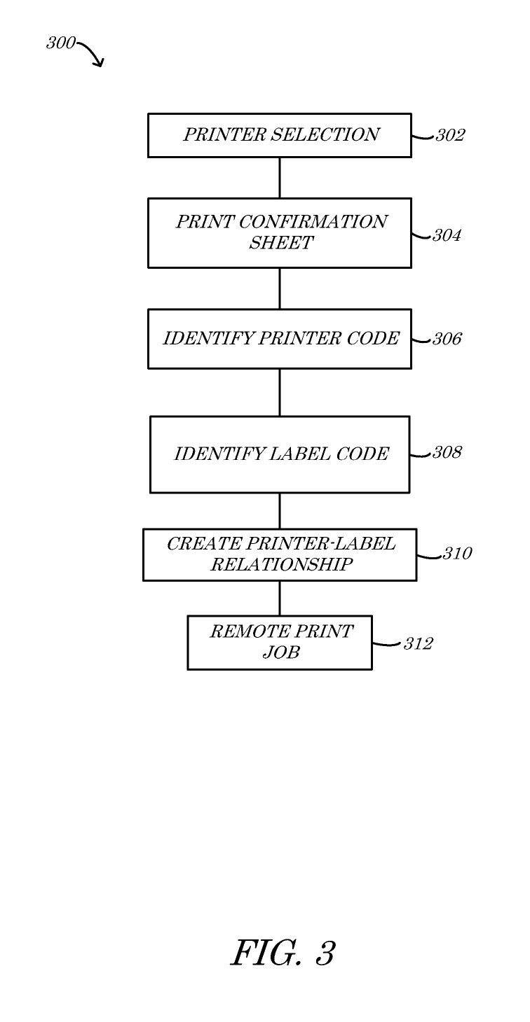

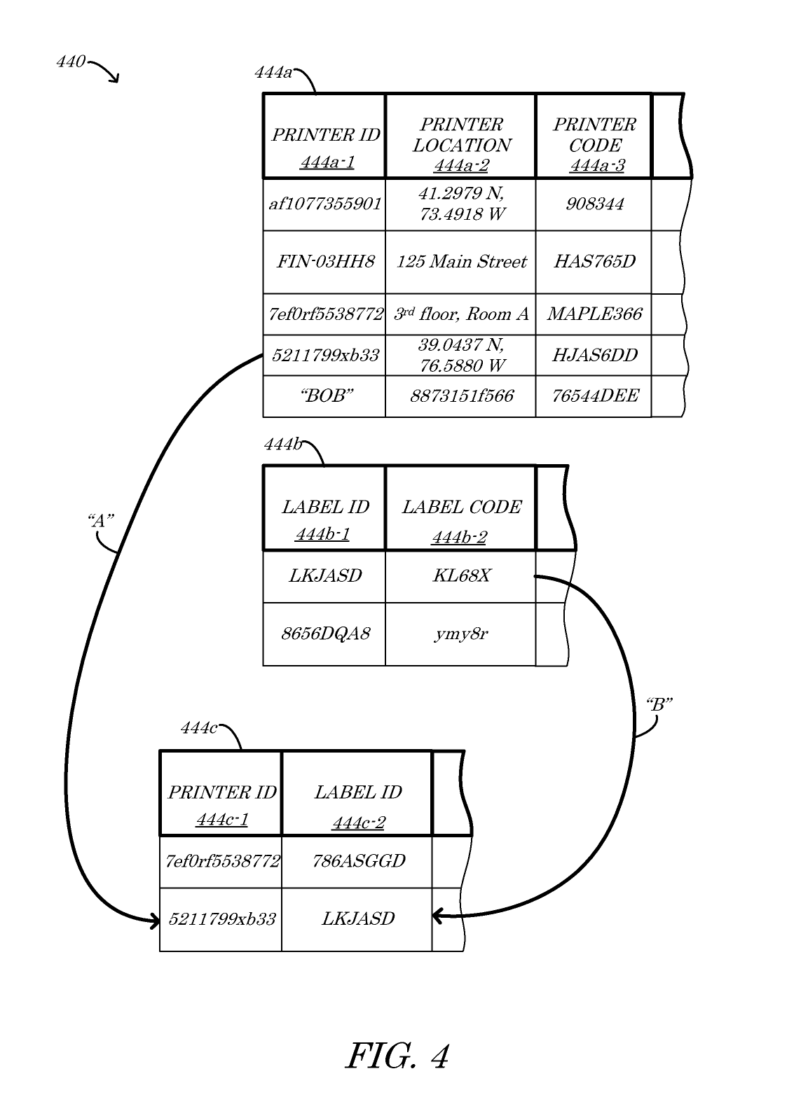

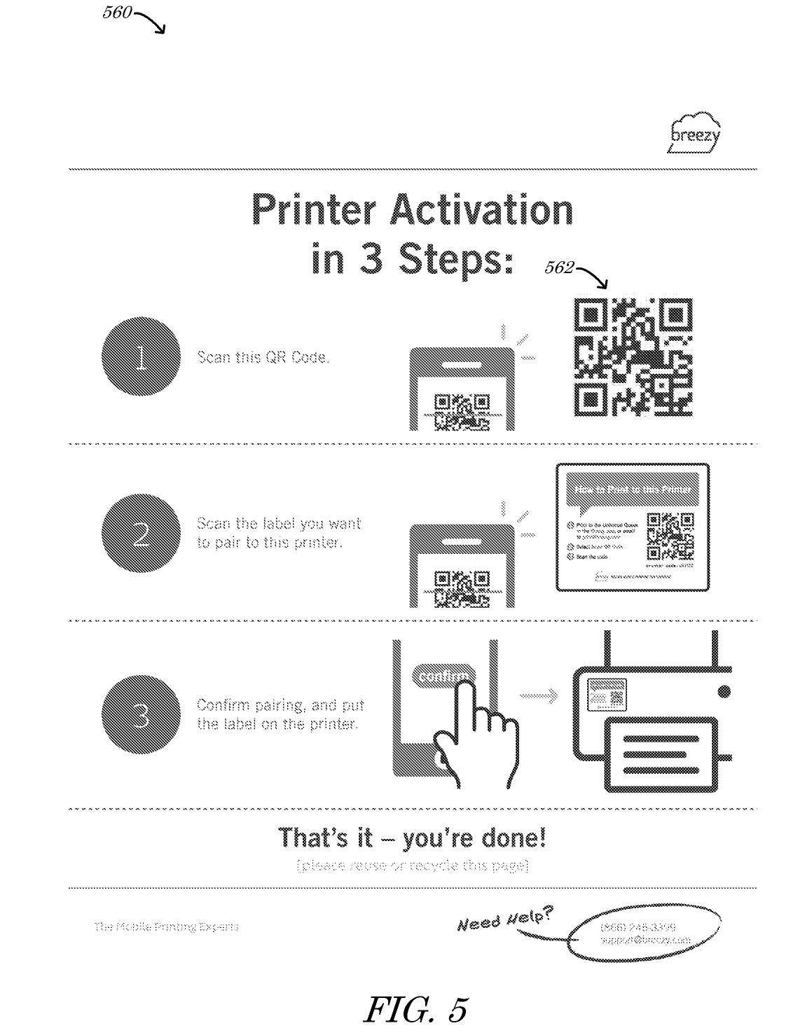

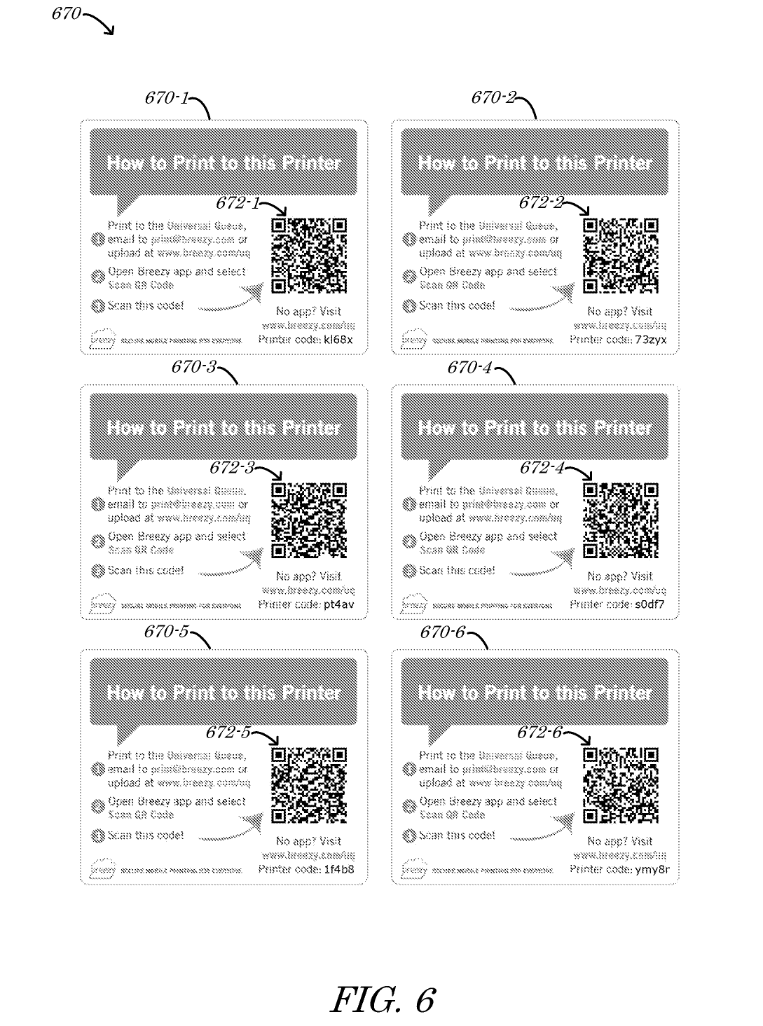

FIG. 1B is provided herein to illustrate the usefulness of the systems and methods of the embodiments described herein for users of mobile devices 120 which are already in communication with an enterprise network 105 that includes an enterprise server 140. A user who receives notification of an email containing an attached document the user would like to print may have an option to print the document to the enterprise printer 150. However, as described above, to take advantage of this printing capability the user would first need either to log into the private enterprise network 105 using a desktop computer (e.g., a mobile device 120) to access the email and attachment via the desktop computer and cause either the enterprise printer 150 (or another printer, but only after logging into the network 105 using a desktop or laptop to access the attachment by a device other than the mobile device 120) to print the document, or be limited to printing the document on the enterprise printer 150 previously selected by an IT professional as the enterprise printer 150 for printing documents from the mobile device 120. In contrast, in accordance with embodiments described herein, the user can previously have made arrangements to associate another printing device (e.g., the third-party printing device 130) with himself (e.g., in accordance with the printer device pairing procedures described herein) and thus make the third-party printing device 130 available for printing from the mobile device 120 merely by selecting a “print” option directly from the mobile device 120 (as will be described in more detail herein with respect to FIG. 3, FIG. 4, FIG. 5, and FIG. 6).

Referring now to FIG. 1C, illustrated therein is a configuration of system 100 that shows a mobile device 120 in communication, via the remote print server 110 (and network 101), with the enterprise network 105, which includes the enterprise server 140 that is in communication with the enterprise printer 150. As depicted, the enterprise network 105 may reside (wholly or at least partially) within (e.g., “behind”) the firewall 103. FIG. 1C is provided herein to illustrate the usefulness of the systems and methods of the embodiments described herein for users of mobile devices 120 which are desired to utilize the enterprise server 150 to remotely print a document, but which are not otherwise in communication with the enterprise network 105 (e.g., behind the firewall 103). In the absence of a properly authorized and established Virtual Private Network (VPN) or other similar secure enterprise connection path, which is not often sanctioned or even possible for many mobile devices for example, without benefit of the remote print server 110 and associated embodiments described herein, the mobile device 120 would not be capable of utilizing the enterprise printer 150 to print a physical document.

Turning now to FIG. 2, illustrated therein is a block diagram of an apparatus 200 (which may comprise, for example, a remote print server 110 or a mobile device 120, each of FIG. 1A and FIG. 1B). The apparatus 200 may be implemented as a system controller, a mobile device application, a dedicated hardware circuit, an appropriately and/or specially programmed general-purpose computer, or any other equivalent electronic, mechanical or electro-mechanical device. The apparatus 200 may comprise, for example, one or more server computers operable to communicate with (a) one or more mobile devices, (b) one or more printing devices and/or (c) one or more additional devices (e.g., a remote storage server device for storing data such as documents to be printed via the apparatus 200). The apparatus 200 may be operative to manage the system 100 of FIG. 1A and/or FIG. 1B, or at least to facilitate some functions or procedures described herein. The apparatus 200, as well as other devices described herein (such as a mobile device 120 and/or a third-party printing device 130), as well as components thereof, may be implemented in terms of hardware, software or a combination of hardware and software.

The apparatus 200 may generally comprise a processor 210, such as one or more INTEL PENTIUM processors (e.g., a processing device). The processor 210 may be in communication with a communication port 220 (e.g., for communicating with one or more other devices, such as one or more mobile devices 120 and/or one or more printing devices 130) and a memory 240. The memory 240 may comprise an appropriate combination of magnetic, optical and/or semiconductor memory, and may include, for example, Random Access Memory (RAM), Read-Only Memory (ROM), smart card, a compact disc and/or a hard disk. The processor 210 and the memory 240 may each be, for example: (i) located entirely within a single computer or other device; or (ii) connected to each other by a remote communication medium, such as a serial port cable, telephone line, USB interface, or radio frequency transceiver. In one embodiment, the apparatus 200 may comprise one or more devices that are connected to a remote server computer for maintaining databases.

The memory 240 (e.g., a non-transitory memory device) may store a program 242-1 for controlling the processor 210. The processor 210 may perform instructions of the program 242-1, and thereby operate in accordance with at least some of the embodiments described in detail herein. The program 242-1 may be stored in a compressed, un-compiled and/or encrypted format. The program 242-1 furthermore includes program elements that may be necessary, such as an operating system, a database management system and “device drivers” for allowing the processor 210 to interface with computer peripheral devices. Appropriate program elements are known to those skilled in the art, and need not be described in detail herein. The memory 240 may also or alternatively store a remote print application 242-2 (which, alternatively, may be part of the program 242-1) which also may be stored in a compressed, un-compiled and/or encrypted format and include instructions which, when performed by the processor 210, cause the processor 210 to operate in accordance with at least some of the embodiments described herein. For example, the remote print application 242-2 may include computer program code that allows the processor 210 to employ the communication port 220 to communicate with a mobile device 120 and/or a third-party printing device 130 in order to, for example:
1. Register a user, including determining a unique user identifier;
2. Determine and store a unique printer identifier for each third-party printing device to be associated with the user identifier (e.g., via utilization of paring procedures as described herein);
3. Receive a request for a print job (i.e., a printing of a document) from a mobile device associated with a user (e.g., a second user);
4. Determine one or more printers within geographic and/or other location-based proximity to a user (and/or a device of a user, such as the mobile device; e.g., as described in conjunction with FIG. 8 herein);
5. Present a graphical and/or map-based interface (e.g., the interface 860 of FIG. 8) from which a user may select one or more of the proximate printers for execution of the print job;
6. Receive, via the graphical and/or map-based interface, a selection, by a user, of one or more of the proximate printers for execution of the print job (thereby defining a printer associated with a user);
7. Queue a print job for printing by a printing device associated with a user and selected by the user for the print job;
8. Receive, process (e.g., standardize—such as by converting to a PDF and/or other widely-accepted and/or universal document format for printing, compress/decompress, encrypt/decrypt), and/or store a document to be printed;
9. Receive a query from a printing device as to a print queue for the printing device;
10. Instruct the printing device to print a document in accordance with print instructions provided by a user who requested the document to be printed and transmit the document to be printed to the printing device;
11. Cause the printing device not to release and/or print the print job until a user (e.g., a user that requested the document to be printed) and/or a device of the user comes within a predetermined proximity thereof and/or takes an action to trigger printing (e.g., define, receive, and/or provide print release trigger rules and/or identifiers or instructions); and/or
12. Determine a print status of a print job and forward (and/or otherwise provide) such to a mobile device of a user.

According to some embodiments, apparatus 200 may be operable to perform some of the processes (or portions thereof) described herein. For example, apparatus 200 may be operable to perform at least a portion of the process 300 (described with respect to FIG. 3), and/or any other process described herein.

According to an embodiment, the instructions of the program 242-1 and/or the remote print application 242-2 may be read into a main memory from another computer-readable medium, such from a ROM to RAM. Execution of sequences of the instructions in the program 242-1 and/or the remote print application 242-2 causes processor 210 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

In some embodiments, the memory 240 may store: (i) a user database 244-1; (ii) a print jobs database 244-2; and/or (iii) a printer database 244-3 (e.g., that stores information regarding the attributes or capabilities of a printing device as well as additional information about the printing device (e.g., the location thereof, number of times used, success rating of jobs transmitted to the printing device, etc.)). Of course, additional or different tables or databases may be used to store information helpful in carrying out the processes described herein. Examples of such additional databases include, but are not limited to, a pre-queue database that stores information about print jobs that have not yet been fully received (e.g., in some embodiments, instructions for how a document is to be printed are received before the document to be printed is received and in such embodiments the instructions may be stored in a pre-queue database until the document is received). In other embodiments, some or all of these functions may be handled by a device distinct from remote apparatus 200.

Although the databases 244-1, 244-2, 244-3 are described as being stored in the memory 240 of the apparatus 200, in other embodiments some or all of these databases may be partially or wholly stored, in lieu of or in addition to being stored in the memory 240 of the apparatus 200, in a memory (not explicitly shown) of one or more other devices. Such one or more other devices may comprise, for example, another computing device with which the apparatus 200 is operable to communicate. Further, some or all of the data described as being stored in the memory 240 may be partially or wholly stored (in addition to or in lieu of being stored in the memory 240) in a memory of one or more other devices. Such one or more other devices may comprise, for example, a remote storage service server (e.g., an online back-up storage server, as would be understood by one of ordinary skill in the art).

In some embodiments the apparatus 200 may be operable to configure a mobile device 120 and/or a third-party printing device 130 remotely, update software stored on either or both such devices and/or to download software or software components to either or both such devices. For example, apparatus 200 may be operable to download (e.g., at the request of a user) software to a mobile device that facilitates the mobile device in using the remote print server to facilitate future print jobs via a third-party printing device 130 by causing the mobile device to generate unique document identifiers for any documents to be printed via the apparatus 200 and by adding a print option on a menu of the mobile device that, when selected by the user, initiates communication with the apparatus 200. In another example, the apparatus 200 may be operable to download (e.g., at the request of a user) software to a third-party printing device 130 that causes the (e.g., remote) third-party printing device 130 to generate a unique identifier for each printer selected by a user, transmit the unique printer identifier as well as any printer attributes associated with each respective third-party printing device 130 to the apparatus 200 and triggers a communication from the third-party printing device 130 to the apparatus 200 to check for a print jobs in a print queue associated with the third-party printing device 130 on the apparatus 200 (e.g., on a periodic, non-periodic, random, continuing or other basis). In such embodiments, also stored in the memory 240 (or in another memory accessible to the processor 210) may be the software for downloading to a mobile device and/or a printing device (e.g., a public and/or third-party printing device). Further, in such embodiments the program 242-1, the remote print application 242-2 or another program or application the processor 210 is operable to access may cause the processor 210 to download such software to the appropriate device upon receiving a recognized request for such download.

The apparatus 200 (as well as a mobile device 120 and/or a third-party printing device 130) may in some embodiments comprise any device operable to facilitate input (not explicitly shown). An input device, as the term is used herein, may be any device, element or component (or combination thereof) that is capable of receiving an input (e.g., from a user or another device). An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port, and a weight scale. For example, in one embodiment an authorized person may use an input device to program or re-program the apparatus 200 to perform a function and/or to write data to one of the databases 244-1, 244-2, 244-3 stored in memory 240.

The apparatus 200 (as well as a mobile device 120 and/or a third-party printing device 130) may in some embodiments comprise one or more output devices (not explicitly shown). An output device may comprise any device, component or element (or a combination thereof) operable to output information from any of the devices described herein. Examples of an output device include, but are not limited to, a display (e.g., in the form of a touch screen), an audio speaker, an infra-red transmitter, a radio transmitter, an electric motor, a dispenser, an infra-red port, a Braille computer monitor, and a coin or bill dispenser.

In some embodiments, the apparatus 200, a mobile device 120 and/or a printing device 130 may comprise components capable of facilitating both input and output functions (i.e., input/output devices). In one example, a touch-sensitive display screen comprises an input/output device (e.g., the device outputs graphics and receives selections from an authorized person).

Turning now to FIG. 3, a flow diagram of a method 300 according to some embodiments is shown. In some embodiments, the method 300 may be implemented, facilitated, and/or performed by or otherwise associated with the system 100 of FIG. 1, the apparatus 200 of FIG. 2, (and/or portions or combinations thereof).

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 240, 440 of FIG. 2, and/or FIG. 4 herein) may store thereon instructions that when executed by a machine (such as a computerized processor) result in performance according to any one or more of the embodiments described herein.

According to some embodiments, the method 300 may comprise receiving (e.g., by a processing device and/or by an input device) first data defining a selection of an available printer (e.g., printing device), at 302. In response to the providing of a menu of available printing devices, for example, a user may select and/or input data identifying one of a plurality of available and/or known or registered printing devices—e.g., printing devices already registered with a remote printing service/system. The receipt of the selection data may, in some embodiments, be accomplished by a mobile electronic device such as a smart phone utilized by the user that receives input from the user via an input device thereof. According to some embodiments, the receiving may be accomplished by a server that is remote from the selected printing device—e.g., a server may receive a transmission from a user's mobile device, the transmission including data defining the selection of the user. In one example of how the method 300 may be effectuated in practice, a user may approach a particular printer (although the approaching would not be necessary at or before 302) and utilize a menu listing output by their portable device to select a representation of the printer (e.g., the printer they have approached and/or that is otherwise desired for selection). According to some embodiments, the receipt of the selection of the printer may not be necessary in the method 300, such as in the case that the printer pairing confirmation page is manually initiated by the user, as described below.

In some embodiments, the method 300 may comprise transmitting (e.g., by the processing device and/or by an output device and/or to the selected printing device) confirmation data or command, at 304, such as for the selected printer to print a confirmation sheet or display a confirmation code on an LCD interface. As the selected printer is generally pre-registered with the remote printing system, for example, once the printer is selected, the system (e.g., an application executed by the mobile device and/or a server) may use the selection information to identify contact information for the selected printer (e.g., a MAC address, e-mail address, etc.). According to some embodiments, the system may utilize the contact information of the selected printer to send a command to the printer. The command (or transmission) may, for example, include data that, once received by the selected printer, causes the printer to print (or otherwise output) a printer pairing confirmation page such as the printer pairing confirmation page 560 of FIG. 5 herein. In some embodiments, such as in the case that the printer stores printer code data such as the data stored in the printer code field 444a-3 of the printer data table 444a of FIG. 4, the command may simply cause the printer to output (e.g., print) such data stored by the printer. According to some embodiments, receipt of such a command from the server and/or mobile device (e.g., the remote printing system) may be the only manner in which such code may be retrieved from the printer—e.g., the code may be maintained secretly and/or in a protected manner. In some embodiments, such as in the case that the printer does not store printer code data such as the data stored in the printer code field 444a-3 of the printer data table 444a of FIG. 4, the command may include an indication of the code for the printer to output (e.g., print). In one of example of how the method 300 may be effectuated in practice, the selected printer (e.g., which has been approached by the user) may print the printer pairing confirmation page, which the user may then acquire (e.g., pick up). In some embodiments, the transmitting of the print command may not be necessary in the method 300, such as in the case that the printer pairing confirmation page is manually initiated by the user. In practice, for example, the user may not know which printer they have approached and may provide input directly to the printer (which is accordingly received by the printer) requesting that the printer output printer pairing data such as via a printing of a physical copy of a printer pairing confirmation page.

According to some embodiments, the method 300 may comprise receiving (e.g., by the processing device and/or by an image capture device) first data defining a first code assigned to a particular label, at 306, which label can be placed on near or otherwise associated with a printer. The portable device and/or server of the remote printing system may, for example, receive input from an image capture and/or scanning device, such input being based on the contents of a particular printed label (e.g., a physical document). In one of example of how the method 300 may be effectuated in practice, the user may utilize their portable device to scan (e.g., utilizing QR™ code scanning application functionality) a code (e.g., the first barcode 672-1 of FIG. 6) printed on a particular label (e.g., the first label 670-1 of FIG. 6) of a sheet of printed labels (e.g., the example page 670 of FIG. 6). The data from the scanned code may be transmitted, for example, to a server of the remote printing system such that the system may establish and/or verify the identity of the particular label. The scanned/captured data acquired by the mobile device may be compared, in some embodiments, to stored data such as the data stored in the label code field 444b-2 of the label data table 444b of FIG. 4, such that a unique label ID may be identified for pairing.

In some embodiments, the method 300 may comprise receiving (e.g., by the processing device and/or by the image capture device) third data defining a second code assigned to the selected printer, at 308. The portable device and/or server of the remote printing system may, for example, receive input from an image capture and/or scanning device, such input being based on the contents of the printer pairing confirmation page. In one example of how the method 300 may be effectuated in practice, the user may utilize their portable device to scan (e.g., utilizing QR™ code scanning application functionality) a code printed on the printer pairing confirmation page (e.g., the barcode 562 of FIG. 5). The data from the scanned code may be transmitted, for example, to a server of the remote printing system such that the system may verify the identity of the printer and/or verify that the selection by the user (e.g., at 302) matches the identity of the printer at which the printer code has been output (e.g., via a printing of the printer pairing confirmation page). The scanned/captured data acquired by the mobile device may be compared, in some embodiments, to stored data such as the data stored in the printer code field 444a-3 of the printer data table 444a of FIG. 4, such that a unique printer ID and/or location may be readily determined by querying an associated database record. Location information for the printer can also be compared with location information for the image capture or input device, e.g., via GPS data, to confirm the two devices are at the designated location for the printer.

According to some embodiments, the method 300 may comprise transmitting (e.g., by the processing device and/or by the output device and/or to a database) a signal defining a data association between the first code and the second code, at 310. The mobile device may transmit a signal to the server, for example, and/or the server may transmit a signal to a database, such signal causing the database to populate data records such as those of the pairing data table 444c of FIG. 4. The data defined by the input received at 306 and 308 may, for example, be utilized to establish a stored indication of a relationship between the printed label and the printer (e.g., a pairing of the label and the printer).

In some embodiments, the method 300 may comprise executing (e.g., by the processing device) a remote print job, at 312. Once the printer and the label have been paired, for example, the remote print server may receive an indication of the label code, such as from a mobile device executing a mobile device remote print application that scans/captures the code from the remote printing label. The server (or mobile device application) may then, for example, utilize the label code to query and/or otherwise identify the paired printer, printer location, and/or printer network or communication address. A print job (e.g., an indication of a document to print, print settings, etc.) received from the mobile device and/or otherwise identified and/or selected by the mobile device may then, for example, be sent to and/or otherwise printed by the printing device paired to the scanned label. The server device may, for example, send a signal to the identified address of the printer, the signal causing the printer to produce a physical document in accordance with the print job parameters. In such a manner, for example, a user having an appropriate mobile device application configured for a remote printing system may simply approach a printer (e.g., a printer for which the identity, settings, type, configuration, location, and/or other attributes or parameters are entirely unknown to the user; i.e., an “unknown printer”), utilize the mobile device and mobile device application to scan a barcode on a remote printing label affixed to the printer (e.g., which may be transmitted to and accordingly received by a remote printing system server), select of identify a print job (which may also be transmitted to the remote printing system server), and collect the desired physical document as it prints from the printer. The method 300 may, for example, provide a seamless user experience that substantially eliminates the necessity of the user having to be involved in the printer identification and selection process beyond simply scanning a label with their smart phone. The system permits IT managers or personnel to conveniently and securely designate printers for use with a remote printing system of the sort described in FIGS. 1A-1C.

Referring now to FIG. 4, a diagram of an example data storage structure 440 according to some embodiments is shown. In some embodiments, the data storage structure 440 may comprise a plurality of data tables such as a printer data table 444a, a label data table 444b, and/or a pairing data table 444c. The data tables 444a-c may, for example, be utilized (e.g., in accordance with the method 300 of FIG. 3 herein) to store, determine, and/or utilize printer, label, user, and/or location data (e.g., provided by a mobile device 120 of FIG. 1 herein), such as pair a printing device with a remote printing network and/or system.

The printer data table 444a may comprise, in accordance with some embodiments, a printer IDentifier (ID) field 444a-1, a printer location field 444a-2, and/or a printer code field 444a-3. Any or all of the number and/or ID fields (e.g., the printer ID field 444a-1) described herein may generally store any type of identifier that is or becomes desirable or practicable (e.g., a unique identifier, an alphanumeric identifier, and/or an encoded identifier). According to some embodiments, the printer data table 444a may generally store data associated with various printing devices associated with a remote printing system (e.g., the system 100 of FIG. 1A and/or FIG. 1B).

In some embodiments, the printer ID field 444a-1 may store data indicative of a printing device. In some embodiments, the printer location field 444a-2 may store data indicative of one or more locational coordinates, labels, directions, and/or other locational and/or geographic identifiers descriptive of a real-world physical location of the printing device. According to some embodiments, the printer code field 444a-3 may store data indicative of a particular code assigned to each particular printing device. The code may, for example, comprise a unique alphanumeric sequence such as a Media Access Control (MAC) address, Burned-In Address (BIA), and/or Ethernet Hardware Address (EHA) formatted and/or configured in accordance with the institute of Electrical and Electronics Engineers (IEEE) Standard 802-2001 titled “The universal administration of LAN MAC addresses began with the Xerox Corporation administering Block Identifiers (Block IDs) for Ethernet addresses” and published Feb. 7, 2002 (ISBN: 0-7381-2941-0) and/or updates or derivations thereof. In some embodiments, the code may comprise data defining one or more barcodes and/or other encoded or encrypted images such as a two-dimensional or three-dimensional barcode (e.g., a Quick Response (QR)™ code).

The label data table 444b may comprise, in accordance with some embodiments, a label ID field 444b-1 and/or label code field 444b-2. According to some embodiments, the label data table 444b may generally store data descriptive of one or more remote printing labels as described herein. The label ID field 444b-1 may store, for example, a unique identifier assigned to a particular physical label (e.g., a label with adhesive backing that is removed from an origination sheet of labels and physically adhered to a real-world surface such as an exterior surface of a housing of a particular printing device). According to some embodiments, the label code field 444b-2 may store data indicative of a particular label. The code may, for example, comprise a unique alphanumeric sequence such as a Media Access Control (MAC) address, Burned-In Address (BIA), and/or Ethernet Hardware Address (EHA) formatted and/or configured in accordance with the institute of Electrical and Electronics Engineers (IEEE) Standard 802-2001 titled “The universal administration of LAN MAC addresses began with the Xerox Corporation administering Block Identifiers (Block IDs) for Ethernet addresses” and published Feb. 7, 2002 (ISBN: 0-7381-2941-0) and/or updates or derivations thereof. In some embodiments, the code may comprise data defining one or more barcodes and/or other encoded or encrypted images such as a two-dimensional or three-dimensional barcode (e.g., a Quick Response (QR)™ code).

According to some embodiments, the pairing data table 444c may comprise a printer ID field 444c-1 and/or a label ID field 444c-2. The pairing data table 444c may generally, for example, store data creating an association or link between a particular printing device (e.g., identified by the data stored in the printer ID field 444c-1) and a particular remote printing label (e.g., identified by the data stored in the label ID field 444c-2). As depicted in the example data storage structure 440, for example, a first relationship “A” may be established between the printer data table 444a and the pairing data table 444c. In some embodiments (e.g., as depicted in FIG. 4), the first relationship “A” may be defined by utilizing the printer ID field 444a-1 as a data key linking to the printer ID field 444c-1. According to some embodiments, the first relationship “A” may comprise any type of data relationship that is or becomes desirable, such as a one-to-many, many-to-many, or many-to-one relationship. In the case that a single printing device is uniquely paired to a single remote printing label, the first relationship “A” may comprise a one-to-one relationship (e.g., one printer per single label).

In some embodiments, the example data storage structure 440 may also define a second relationship “B” established between the label data table 444b and the pairing data table 444c. In some embodiments (e.g., as depicted in FIG. 4), the second relationship “B” may be defined by utilizing the label ID field 444b-1 as a data key linking to the label ID field 444c-2. According to some embodiments, the second relationship “B” may comprise any type of data relationship that is or becomes desirable, such as a one-to-many, many-to-many, or many-to-one relationship. In the case that a single printing device is uniquely paired to a single remote printing label, the second relationship “B” may comprise a one-to-one relationship (e.g., one printer per single label). In such a manner, for example, the particular printer at a particular location (e.g., having particular print capabilities) may be linked or paired with a particular remote printing label (e.g., which can be utilized to quickly and easily send a remote print job to the particular printer via the remote print system described herein).

In some embodiments, fewer or more data fields than are shown may be associated with the data tables 444a-c. Only a portion of one or more databases and/or other data stores is necessarily shown in the data storage structure 440 of FIG. 4, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein nor imply that any such data is accurate.

Referring now to FIG. 5, a diagram of an example printer pairing confirmation page 560 according to some embodiments is shown. The printer pairing confirmation page 560 may, for example, be printed and/or otherwise output (e.g., in physical form or on a screen) by a printing device in response to a command received from a remote print server and/or mobile device, such as at 304 in the method 300 of FIG. 3 herein. According to some embodiments, the printer pairing confirmation page 560 may comprise a visual and/or machine-readable representation of a code such as a barcode 562. The barcode 562 may, in some embodiments, comprise a QR™ code as depicted and/or may store encoded information such as the printer code stored in the printer code field 444a-3 of the printer data table 444a of FIG. 4 herein. In such a manner, for example, and as depicted by the written user instructions on the printer pairing confirmation page 560, a user may easily and quickly pair a particular printer with a particular remote printing system label, as described herein. The user may, for example, scan the barcode 562 with a portable electronic device (not shown in FIG. 5) comprising an image capture device or other machine-readable acquisition device (e.g., a barcode scanner) to cause an application executed by the mobile device to identify the particular printer that has printed the printer pairing confirmation page 560.

Turning to FIG. 6, a diagram of an example page 670 of six (6) remote printing labels 670-1, 670-2, 670-3, 670-4, 670-5, 670-6 according to some embodiments is shown. The example page 670 may, for example, be printed and/or otherwise output (e.g., in physical form on a tangible medium) by a printing device. According to some embodiments, the example page 670 and/or one or more of the remote printing labels 670-1, 670-2, 670-3, 670-4, 670-5, 670-6 (e.g., each of the remote printing labels 670-1, 670-2, 670-3, 670-4, 670-5, 670-6) may comprise a visual and/or machine-readable representation of a code such as a barcode 672-1, 672-2, 672-3, 672-4, 672-5, 672-6. The barcode 672-1, 672-2, 672-3, 672-4, 672-5, 672-6 may, in some embodiments, comprise a QR™ code as depicted and/or may store encoded information such as the label code stored in the label code field 444b-2 of the label data table 444b of FIG. 4 herein. In such a manner, for example, and as depicted by the written user instructions on example page 670 (e.g., on the remote printing labels 670-1, 670-2, 670-3, 670-4, 670-5, 670-6), a user may easily and quickly pair a particular printer (not shown in FIG. 6) with a particular remote printing system label 670-1, 670-2, 670-3, 670-4, 670-5, 670-6, as described herein. The user may, for example, scan one of the barcodes 672-1, 672-2, 672-3, 672-4, 672-5, 672-6 such as a first one of the barcodes 672-1 (of a first remote printing system label 670-1) with a portable electronic device (not shown in FIG. 6) comprising an image capture device or other machine-readable acquisition device (e.g., a barcode scanner) to cause an application executed by the mobile device to identify the particular first remote printing system label 670-1. In some embodiments, the user may utilize the image capture/scanning device to also scan/input the barcode 562 of the printer pairing confirmation page 560, which may trigger or cause the application to create a link between the two separately-scanned barcodes 562, 672-1 (e.g., creating a stored association between a particular printer and a particular label).

### Rules of Interpretation

Numerous embodiments are described in this patent application, and are presented for illustrative purposes only. The described embodiments are not, and are not intended to be, limiting. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. It is contemplated, however, that while some embodiment are not limited by the examples provided herein, some embodiments may be specifically bounded or limited by provided examples, structures, method steps, and/or sequences. Embodiments having scopes limited by provided examples may also specifically exclude features not explicitly described or contemplated.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise. Similarly, any reference to an “alternate”, “alternative”, and/or “alternate embodiment” is intended to connote one or more possible variations—not mutual exclusivity. In other words, it is expressly contemplated that “alternatives” described herein may be utilized and/or implemented together, unless they inherently are incapable of being utilized together.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”. In some embodiments, a first thing being “based on” a second thing refers specifically to the first thing taking into account the second thing in an explicit manner. In such embodiments, for example, a processing step based on the local weather, which itself is in some manner based on or affected by (for example) human activity in the rainforests, is not “based on” such human activities because it is not those activities that being explicitly analyzed, included, taken into account, and/or processed.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “wherein”, as utilized herein, does not evidence intended use. The term “wherein” expressly refers to one or more features inclusive in a particular embodiment and does not imply or include an optional or conditional limitation.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein. According to some embodiments, a “processor” may primarily comprise and/or be limited to a specific class of processors referred to herein as “processing devices”. “Processing devices” are a subset of processors limited to physical devices such as CPU devices, Printed Circuit Board (PCB) devices, transistors, capacitors, logic gates, etc. “Processing devices”, for example, explicitly exclude biological, software-only, and/or biological or software-centric physical devices. While processing devices may include some degree of soft logic and/or programming, for example, such devices must include a predominant degree of physical structure in accordance with 35 U.S.C. §101.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

While various embodiments have been described herein, it should be understood that the scope of the present invention is not limited to the particular embodiments explicitly described. Many other variations and embodiments would be understood by one of ordinary skill in the art upon reading the present description.

What is claimed is:

1. A system for facilitating the remote printing of a document, comprising:
an image capture device;
a processing device in communication with the image capture device;
an input device in communication with the processing device;
an output device in communication with the processing device; and
a memory in communication with the processing device, the memory storing instructions that when executed by the processing device result in:
receiving, from the input device and by the processing device, data identifying a printer;
receiving, from the image capture device and by the processing device, a code to be associated with the printer;
transmitting, by the output device and to the printer, a command to print or convey a confirmation code;
receiving, from the image capture device and by the processing device, the confirmation code; and
associating, the printer code with the printer that printed or otherwise conveyed the confirmation code.

2. The system of claim 1, wherein the instructions, when executed by the processing device, further result in:
providing, by the output device and to a user, a menu listing a plurality of available printers.

3. The system of claim 1, wherein the transmitting is conducted by transmitting the command to print or convey a confirmation code to a server in communication with the selected printer.

4. The system of claim 1, wherein the command comprises a command to the printer to provide a visual indication of the confirmation code via an electronic display.

5. The system of claim 1, wherein the command comprises a command to the printer to print a confirmation sheet including a visual indication of the confirmation code.

6. The system of claim 1, wherein at least one of the printer code or confirmation code is received via the input device.

7. The system of claim 1, wherein associating the printer label with the printer that printed or conveyed the confirmation code comprises the creation of one or more entries in a database.

8. The system of claim 1, wherein at least one of the printer code or confirmation code are defined in a two-dimensional barcode format.

9. The system of claim 1, wherein at least one of the printer code and/or confirmation code are defined in a three-dimensional barcode format.

10. The system of claim 3, wherein the transmitting further includes information about the physical location of the printer;

11. The system of claim 3, wherein the association further includes storing information about the physical location of the printer.

12. A system for facilitating the remote printing of a document comprising:
using a mobile device to pair a visually displayable code or label with a printer by associating the code with a confirmation code printed or conveyed by the printer.
